(19) United States
(12) Patent Application Publication
(10) Pub. No.: US 2025/0037341 A1
(43) Pub. Date: Jan. 30, 2025

(54) LOCAL IDENTITY-AWARE FACIAL RIG GENERATION

(71) Applicant: DISNEY ENTERPRISES, INC., Burbank, CA (US)

(72) Inventors: Prashanth CHANDRAN, Zürich (CH); Gaspard ZOSS, Zürich (CH); Derek Edward BRADLEY, Zürich (CH); Josefine Estrid KLINTBERG, Nürich (SE); Paulo Fabiano URNAU GOTARDO, Zürich (CH)

(21) Appl. No.: 18/786,337

(22) Filed: Jul. 26, 2024

Related U.S. Application Data
(60) Provisional application No. 63/516,248, filed on Jul. 28, 2023.

(51) Int. Cl. G06T 13/40; G06T 17/20

(52) U.S. Cl. CPC G06T 13/40; G06T 17/20

(57) ABSTRACT

The present invention sets forth a technique for performing facial rig generation. The technique includes generating a blendshape model including a plurality of vertices, a plurality of meshes, and a plurality of patches. The technique also includes modifying one or more blendweight values associated with each of the plurality of patches based on a plurality of facial depictions included in a facial database and one or more sample depictions of a target character and generating an output facial rig model based on the blendshape model and the one or more modified blendweight values. The technique further includes generating one or more expressive depictions of the target character based at least on the output facial rig.

### CROSS-REFERENCE TO RELATED APPLICATIONS

This application claims priority benefit of U.S. Provisional Patent Application titled “LOCAL IDENTITY-AWARE FACIAL RIG GENERATION,” Ser. No. 63/516,248, filed Jul. 28, 2023. The subject matter of this related application is hereby incorporated herein by reference.

### BACKGROUND

### Field of the Various Embodiments

Embodiments of the present disclosure relate generally to computer animation and, more specifically, to techniques for performing facial rig generation.

### Description of the Related Art

Facial rig generation is a critical component of virtual production platforms, games, augmented reality, virtual reality, and other interactive applications. While a static representation of an animatable character (e.g. a static mesh representation) may be sufficient to portray the character exhibiting a single facial expression, a static representation is not suitable to accurately describe complex deformations of the character's face over time. In facial rig generation, an animator creates an adaptable model that represents a target character's head and/or face. The animator adjusts the facial rig to produce realistic movements and deformations in the model to mimic time-varying expressions in the target actor. The animator may adjust the facial rig manually, or the adjustments may be driven by collected data, such as facial scans, still images, or video recordings of the human actor.

Existing techniques for generating facial rigs may rely on blendshape models that include dozens or hundreds of blendshapes, where each blendshape may include, e.g., a three-dimensional (3D) scan or a digitally-sculpted 3D depiction of the character exhibiting a different facial expression. To generate a depiction of the character with a desired facial expression, the animator develops a weighted, linear combination of the multiple blendshapes. These techniques, while computationally efficient, require that the animator manually create a large number of blendshapes, including complex corrective blendshapes that capture a fine level of detail and describe non-linear deformations in the actor's face. Even with significant manual adjustment, these linear techniques may not produce accurate depictions of even basic motion.

Other existing techniques may include complex, nonlinear methods for depicting facial expressions. These nonlinear methods do not provide an intuitive and modifiable interface for animators and are used primarily for reconstruction of a single depiction of a facial expression, rather than for modifying an underlying facial rig to generate time-varying expressions in a facial model. These techniques are generally unsuitable for animation production environments, as artistic alterations or modifications are both difficult and time-consuming.

As the foregoing illustrates, what is needed in the art are more effective techniques for performing facial rig generation.

### SUMMARY

One embodiment of the present invention sets forth a technique for performing facial rig generation. The technique includes generating a blendshape model including a plurality of vertices, a plurality of meshes, and a plurality of patches and modifying one or more blendweight values associated with each of the plurality of patches based on a plurality of facial depictions included in a facial database and one or more sample depictions of a target character. The technique also includes generating an output facial rig model based on the blendshape model and the one or more modified blendweight values and generating one or more expressive depictions of the target character based at least on the output facial rig.

One technical advantage of the disclosed techniques relative to the prior art is that the disclosed techniques are operable to generate a facial rig for a particular animated character using only a limited number of depictions of the character. Various embodiments of the disclosed techniques may also be guided and constrained by character depictions including studio images or in-the-wild images, rather than requiring 3D scans or digitally-sculpted 3D depictions of a character's face. Further, the disclosed techniques improve accuracy and realism in generated facial expressions via a patch-based optimization method, where the disclosed techniques process a facial representation as a collection of independent regions within the representation, rather than as a monolithic whole. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the blendshape engine of FIG. 1, according to some embodiments.

FIG. 3 is a flow diagram of method steps for performing identity-based facial rig generation based on neutral facial depictions, according to some embodiments.

FIG. 4 is a flow diagram of method steps for performing identity-based facial rig generation based on neutral facial depictions and vertex optimization, according to some embodiments.

FIG. 5 is a flow diagram of method steps for performing identity-based facial rig generation based on neutral and expressive depictions, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

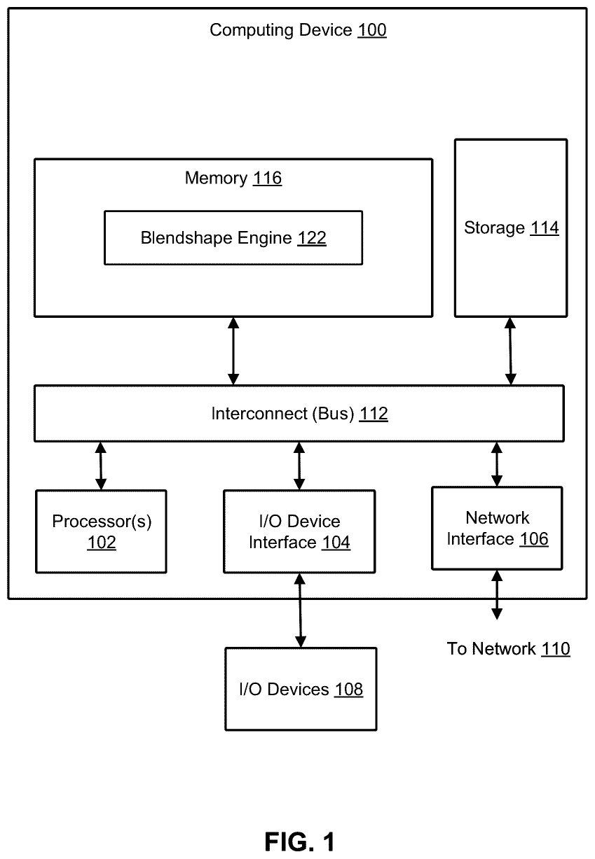

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a blendshape engine 122 that resides in a memory 116.

It is noted that the computing device described herein is illustrative and that any other technically feasible configurations fall within the scope of the present disclosure. For example, multiple instances of blendshape engine 122 could execute on a set of nodes in a distributed and/or cloud computing system to implement the functionality of computing device 100. In another example, blendshape engine 122 could execute on various sets of hardware, types of devices, or environments to adapt blendshape engine 122 to different use cases or applications. In a third example, blendshape engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Blendshape engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including blendshape engine 122.

### Identity-Aware Local Automatic Facial Rig Generation

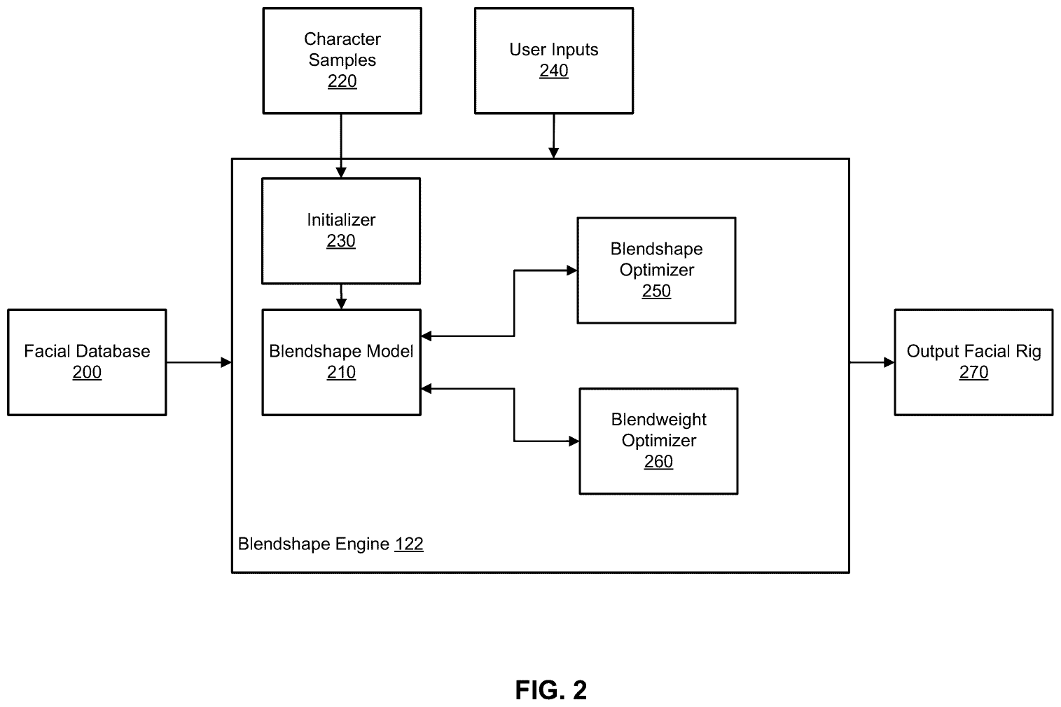

FIG. 2 is a more detailed illustration of blendshape engine 122 of FIG. 1, according to some embodiments. Blendshape engine 122 generates an adaptable blendshape model 210 corresponding to a target character. Blendshape engine 122 optimizes blendshape model 210 based on one or more expressive character samples 220 of the target character and a facial database 200 containing both neutral and expressive facial depictions associated with multiple identities that are different from the target character. Blendshape engine 122 generates an output facial rig 270 based on optimized blendshape model 210. Blendshape engine also includes, without limitation, initializer 230, blendshape optimizer 250, and blendweight optimizer 260.

Facial database 200 includes multiple depictions of faces, where each depiction is associated with one of multiple different identities. In various embodiments, facial database 200 may include depictions associated with hundreds of different identities. Each depiction included in facial database 200 includes a view of a face centered in a canonical coordinate system. Each depiction includes a set of vertices describing the physical structure of the face, as well as a set of triangular meshes defined by vertices included in the set of vertices. The triangular meshes represent various surfaces included in the face. Each depiction further includes a set of user-defined patches, where each patch is associated with a region of the depicted face. In various embodiments, adjacent patches included in a depiction may overlap one another at or near a boundary separating the adjacent patches.

Depictions included in facial database 200 may represent a neutral visual representation associated with a particular identity included in the multiple different identities. A neutral visual representation does not portray a specific emotion, and facial features such as eyes, a nose, eyebrows, or a mouth included in a neutral visual representation are portrayed in their respective resting, non-distorted positions. Depictions included in facial database 200 may also include one or more expressive visual representations associated with each of the multiple different identities. Expressive visual representations may portray a specific emotion via deformations and/or displacements of one or more facial features from their resting, non-distorted positions. Emotions portrayed in expressive visual representations may include, but are not limited to, surprise, anger, shock, happiness, confusion, or sadness. Expressive visual representations may also include distortions of one or more facial features that may not be associated with a particular emotion, such as inflated cheeks, raised eyebrow(s), pursed lips, widened eyes, or a stretched mouth.

Character samples 220 include one or more depictions of a single target character. Blendshape engine 122 optimizes blendshape model 210 based on the one or more depictions included in character samples 220, as described below. Notably, character samples 220 do not include a neutral facial depiction of the target character; each of character samples 220 may include a depiction of the target character expressing an emotion, e.g., sadness, happiness, anger, confusion, or shock. Each of character samples 220 may include a depiction of the target character exhibiting distortions of one or more facial features, such as inflated cheeks, raised eyebrow(s), pursed lips, widened eyes, or a stretched mouth. These distortions, while expressive, may not be associated with a particular emotion. In various embodiments, character samples 220 may include a limited number of target character depictions, e.g., fewer than ten depictions. In various embodiments, the depictions may include digitally sculpted 3D representations of faces. The depictions may also include 3D scans of a target character, and/or rasterized image data depicting the target character, such as studio photographs or photographs taken outside of a studio environment. In the case of rasterized image data depicting the target character, blendshape engine 122 may analyze the rasterized image data, detect facial landmarks via any suitable facial recognition techniques, and generate vertices and meshes representing the facial landmarks. The depictions need not be centered at the origin of a canonical coordinate system, as blendshape engine 122 is operable to calculate a global rigid transformation associated with the depiction that may rotate or translate the depiction as described below to place the depiction in an upright orientation at the origin of the canonical coordinate system.

In various embodiments, each depiction included in character samples 220 also includes multiple patches, where each patch is associated with a region of the depiction. Each patch included in a depiction may be associated with a corresponding patch included in a depiction from facial database 200. Adjacent patches associated with a depiction included in character samples 220 may overlap one another at or near a boundary separating the adjacent patches.

Blendshape model 210 includes a set of vertices and triangle meshes centered at the origin of a canonical coordinate system. Blendshape model 210 also includes multiple patches, where each patch is associated with a region included in blendshape model 210. The user-supplied patch layout is the same as the patch layouts described above in reference to the depictions included in facial database 200 and character samples 220, such that each patch included in blendshape model 210 is associated with corresponding patches in character samples 220 and facial database 200 that include similar facial regions. Blendshape engine 122 iteratively optimizes the shape and/or identity weights of patches included in blendshape model 210 as described below.

Initializer 230 generates initial estimated values for a set of blendweights associated with each patch included in blendshape model 210. For each patch, the set of blendweights define a linear weighted combination of one or more corresponding patches included in depictions in facial database 200. For each depiction included in character samples 220, initializer 230 generates the initial estimated set of blendweight values based on a comparison between the character sample depiction and one or more depictions included in facial database 200. Blendshape engine 122 iteratively modifies the initial estimated blendweight values as described below.

For each depiction included in character samples 220, initializer 230 generates an initial estimate for a global transformation associated with the depiction. In various embodiments, the global transformation may include one or more rotation and/or translation matrices that, when applied to the depiction, place the depiction upright and at the origin of the canonical coordinate system. For instance, initializer 230 may generate the one or more rotation and/or translation matrices such that the geometric center of the depiction is translated to the origin of the canonical coordinate system, and facial features included in the depiction are oriented correctly, e.g., two eyes included in a depiction are aligned horizontally. Blendshape engine 122 iteratively modifies the initial estimated global transformation as described below.

User input 240 may include the user-defined patch layout as described above in reference to facial database 200, character samples 220, and blendshape model 210. In various embodiments, user input 240 may also include user-specified modifications to blendweight values associated with one or more patches included in blendshape model 210. For example, a user may provide a scalar strength factor that is then multiplied by all blendweight values included in blendshape model 210, or to only the blendweight values associated with one or more patches included in blendshape model 210. User inputs 240 may also include per-depiction preference values associated with one or more depictions included in facial database 200. In various embodiments, each depiction included in facial database 200 may be assigned a default preference value, e.g., 1. Blendshape engine 122 may penalize the use of a particular depiction in facial database 200 if the user has assigned a preference value of less than 1 to the particular depiction. Blendshape engine 122 may favor the use of a particular depiction in facial database 200 if the user has assigned a preference value of less than 1 to all other depictions included in facial database 200.

Blendweight optimizer 260 generates an optimized set of blendweight values associated with each patch included in blendshape model 210 such that blendshape model 210 represents a selected depiction included in character samples 220. As discussed above, a set of blendweight values associated with a patch included in blendshape model 210 defines a weighted linear combination of one or more patches included in facial database 200. Blendweight optimizer 260 simultaneously optimizes the global transformation associated with the character sample included in character samples 220. While optimizing the character sample global transformation and the blendweights for each patch included in blendshape model 210, blendweight optimizer 260 holds the positions of each vertex in blendshape model 210 fixed. Blendweight optimizer 260 modifies the blendweights and the global transformation via minimization of a loss function that represents per-patch differences between blendweights included in the character sample and corresponding blendweights included in blendshape model 210.

In various embodiments, blendweight optimizer 260 may regularize the blendweight values to remain close to zero by minimizing regularization energy EReg:

$${E}_{Reg} = {\sum }_{p ∈ P} {\sum }_{i = 0}^{N - 1} {( {α}_{p , i} )}^{2} \qquad ( Equation 1 )$$

where α_{p,i} represents a blendweight value associated with a patch p included in blendshape model 210 and N represents a number of facial depictions included in facial database 200.

In various embodiments, blendweight optimizer 260 may minimize overlap energy E_{O} to enforce blendweight value consistency in adjacent patches included in blendshape model 210:

$${E}_{O} = {\sum }_{p ∈ P} {\sum }_{q ∈ N ( p )} {\sum }_{i = 0}^{N - 1} ( {α}_{p , i} - {α}_{q , i} ) \qquad ( Equation 2 )$$

where [symbol] (p) defines the patches adjacent to p.

Blendshape optimizer 250 iteratively optimizes one or more vertex positions included in blendshape model 210 based on facial depictions included in facial database 200 and character depictions included in character samples 220. For each patch included in blendshape model 210, blendshape optimizer 250 modifies the position of one or more vertices associated with the patch. While optimizing the one or more vertex positions, blendshape optimizer 250 holds the blendweight values and global transformation generated by blendweight optimizer 260 as discussed above fixed. In various embodiments, blendshape optimizer 250 may regularize the optimized vertex positions via minimization of individual vertex displacements.

In various embodiments, blendshape engine 122 alternately executes blendweight optimizer 260 and blendshape optimizer 250 to iteratively optimize the patch blendweight values and vertex positions included in blendshape model 210. In various embodiments, blendshape engine 122 may repeatedly optimize blendshape model 210 for each character depiction included in character samples 220, and may alternate between optimizing blendweight values and vertex positions for a fixed number of executions or until one or more of the optimization energy functions are below a predetermined threshold.

After optimizing one or more of the blendweight values, global transformation, and vertex positions included in blendshape engine 122, blendshape engine 122 generates output facial rig 270. Output facial rig 270 represents the target character and includes the optimized per-patch blendweight values and vertex positions from optimized blendshape model 210.

### Identity-Based Facial Rig Generation Based on Neutral Facial Depictions

In one embodiment of the disclosed invention, blendshape engine 122 leverages only the neutral expressions associated with each identity included in facial database 200 when generating and optimizing blendshape model 210. For all or a subset of the identities included in facial database 200, blendshape engine 122 selects a neutral expression depiction included in facial database 200 that is associated with the identity. Blendshape engine 122 generates blendshape model 210 as a patch-based linear identity model, where a set of blendweight values associated with each patch included in blendshape model 210 define a linear weighted combination of corresponding patches included in the neutral expressions of facial database 200. During optimization, blendweight optimizer 260 modifies the set of blendweight values associated with each of the one or more patches included in blendshape model 210 based on character depictions included in character samples 220, as discussed above in the description of FIG. 2. In this embodiment of the present invention, blendshape engine 122 may omit blendshape optimizer 250 and the optimization of vertex positions included in blendshape model 210. Blendshape engine 122 may iteratively modify the blendweight values based on the calculated regularization energy and overlap energy (Equations 1 and 2 discussed above).

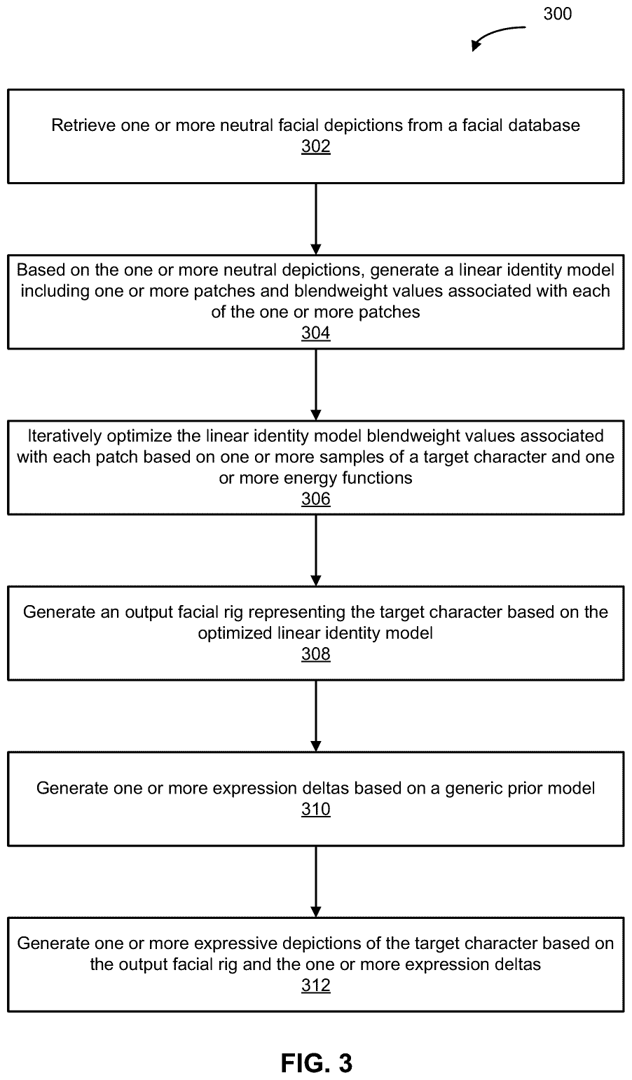

In this embodiment, blendshape engine 122 transfers expression deltas from a generic prior model (not shown) to optimized blendshape model 210 to generate target character expressions. An expression delta describes positional differences between the vertex positions included in a neutral facial depiction of the generic prior model and an expressive depiction of the generic prior model. For example, given a generic prior model that includes both a neutral facial depiction and an expressive depiction of the generic prior model smiling, blendshape engine 122 may calculate a smile expression delta based on the different positions of corresponding vertices in the neutral facial depiction and the expressive smiling depiction. Blendshape engine 122 may apply the smile expression delta to optimized blendshape model 210 and generate a model representing the target character smiling. The method steps included in this embodiment of the present invention are discussed below in the description of FIG. 3.

### Identity-Based Facial Rig Generation Based on Neutral Facial Depictions and Vertex Optimization

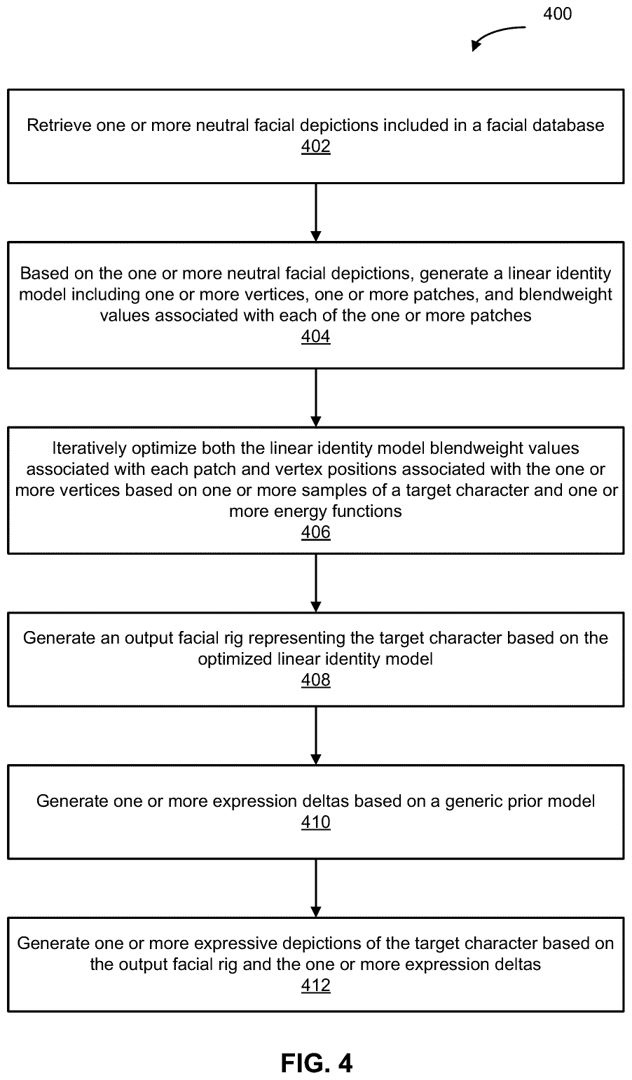

In another embodiment of the disclosed invention, blendshape engine 122 again leverages only the neutral expressions associated with each identity included in facial database 200 when generating and optimizing blendshape model 210. For all or a subset of the identities included in facial database 200, blendshape engine 122 selects a neutral expression depiction included in facial database 200 that is associated with the identity. Blendshape engine 122 generates blendshape model 210 as a patch-based linear identity model, where a set of blendweight values associated with each patch included in blendshape model 210 define a linear weighted combination of corresponding patches included in the neutral expressions of facial database 200. During optimization, blendweight optimizer 260 modifies the set of blendweight values associated with each of the one or more patches included in blendshape model 210 based on character depictions included in character samples 220, as discussed above in the description of FIG. 2. In this embodiment of the present invention, blendshape engine 122 also optimizes the positions of one or more vertices included in blendshape model 210. Blendshape engine 122 may iteratively modify both the blendweight values and the vertex positions associated with each patch included in blendshape model 210, as discussed above in the description of FIG. 2. By adjusting both the blendweight values and the vertex positions associated with each patch included in blendshape model 210, this embodiment optimizes for identity-specific differences between facial structures included in facial database 200 and the facial structures included in character samples 220. The method steps included in this embodiment of the present invention are discussed below in the description of FIG. 4.

### Identity-Based Facial Rig Generation Based on Neutral and Expressive Depictions

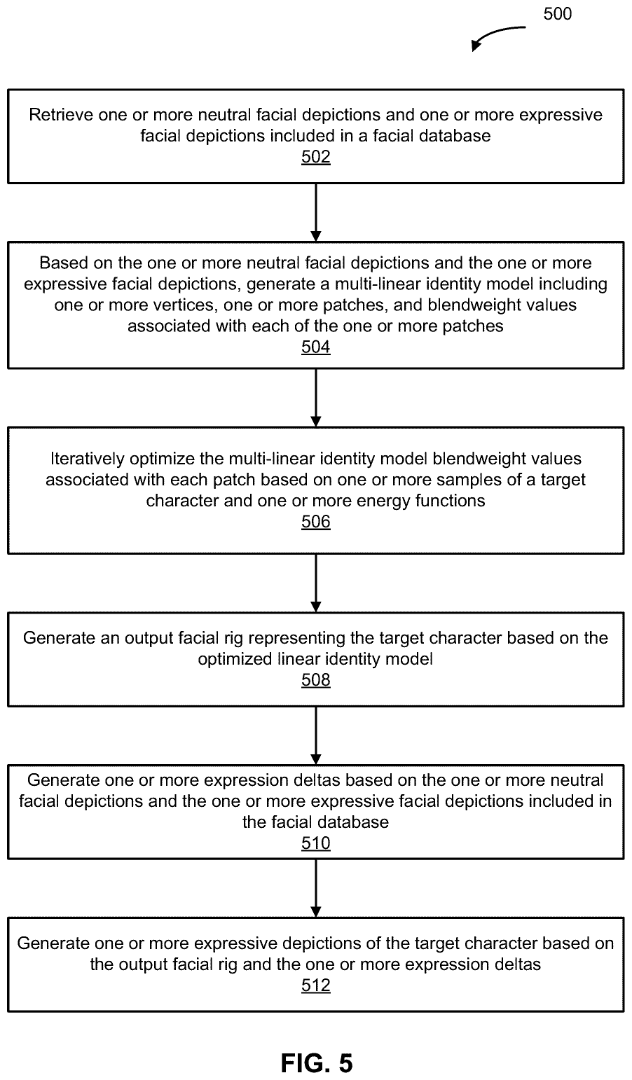

In yet another embodiment of the disclosed invention, blendshape engine 122 leverages both the identities and the expressions included in facial database 200. In this embodiment, blendshape engine 122 extends blendshape model 210 to include a patch-based multi-linear model. In the patch-based multilinear model, blendweight values associated with each patch included in blendshape model 210 encode an identity included in facial database 200 along one tensor dimension, and an expression associated with the identity along a second, orthogonal tensor dimension. When optimizing blendshape model 210, blendshape engine 122 may omit blendshape optimizer 250 and optimize only the blendweight values associated with each patch included in blendshape model 210 as discussed above in the description of FIG. 2. After optimizing blendshape model 210, blendshape engine 122 generates output facial rig 270 that represents the target character depicted in character samples 220. Blendshape engine 122 further generates a set of expression deltas based on blendweight values included in optimized blendshape model 210 and the neutral and expressive depictions included in facial database 200. Each expression delta in the set of expression deltas describes positional differences between the vertex positions included in a weighted linear combination of neutral facial depictions included in facial database 200 and a weighted linear combinations of depictions included in facial database 200 and associated with a particular expression. For example, one expression delta included in the set of expression deltas may describe positional vertex differences between a weighted combination of the multiple neutral facial depictions associated with multiple identities and a weighted combination of frowning expressive depictions associated with the multiple identities. Blendshape engine 122 calculates the weighted combinations based on the multi-linear blendweight values included in blendshape model 210. Blendshape engine 122 may generate an expressive depiction of the target character by applying an expression delta included in the set of expression deltas to the target character model included in output facial rig 270. The method steps included in this embodiment of the present invention are discussed below in the description of FIG. 5.

FIG. 3 is a flow diagram of method steps for performing identity-based facial rig generation based on neutral facial depictions, according to some embodiments. Although the method steps are described in conjunction with the systems of FIGS. 1 and 2, persons skilled in the art will understand that any system configured to perform the method steps in any order falls within the scope of the present disclosure.

As shown, in operation 302 of method 300, blendshape engine 122 retrieves one or more neutral facial depictions included in facial database 200. Each of the one or more neutral facial depictions is associated with one of one or more different identities included in facial database 200.

In operation 304, blendshape engine 122 generates blendshape model 210, where blendshape model 210 includes a linear identity model. Blendshape model 210 includes multiple vertices, multiple meshes defined by the vertices, and multiple patches, where each patch is associated with a region of blendshape model 210. Each patch includes a set of blendweight values associated with the patch, where the blendweight values define a per-patch linear combination of the neutral facial depictions included in facial database 200.

In operation 306, blendshape engine 122 iteratively optimizes the blendweight values associated with each patch included in blendshape model 210 via blendweight optimizer 260. Blendshape engine 122 optimizes the blendweight values based on one or more samples of a target character and one or more energy function values. As discussed above in the description of FIG. 2, blendweight optimizer 260 minimizes one or more of a fitting energy value, regularization energy value, or overlap energy value. Blendshape engine 122 may optimize the blendweight values associated with the multiple patches for a predetermined number of iterations or until one or more of the energy function values is below a predetermined threshold.

In operation 308, blendshape engine 122 generates output facial rig 270. Output facial rig 270 includes an adjustable model representing the target character, where the adjustable model includes multiple vertices and multiple meshes defined by the multiple vertices.

In operation 310, blendshape engine 122 generates one or more expression deltas based on a generic prior model. Each expression delta of the one or more expression deltas represents differences in vertex positions between a neutral facial depiction of the generic prior model and an expressive depiction of the generic prior model, such as a depiction where the generic prior model includes a smiling or frowning expression.

In operation 312, blendshape engine 122 generates one or more expressive depictions of the target character based on output facial rig 270 and the one or more expression deltas. Each expression delta, when applied to output facial rig 270, generates a depiction of the target character exhibiting the expression associated with the expression delta, e.g., smiling or frowning.

FIG. 4 is a flow diagram of method steps for performing identity-based facial rig generation based on neutral facial depictions and vertex optimization, according to some embodiments. Although the method steps are described in conjunction with the systems of FIGS. 1 and 2, persons skilled in the art will understand that any system configured to perform the method steps in any order falls within the scope of the present disclosure.

As shown, in operation 402 of method 400, blendshape engine 122 retrieves one or more neutral facial depictions included in facial database 200. Each of the one or more neutral facial depictions is associated with one of one or more different identities included in facial database 200.

In operation 404, blendshape engine 122 generates blendshape model 210, where blendshape model 210 includes a linear identity model. Blendshape model 210 includes one or more vertices, one or more meshes defined by the vertices, and one or more patches, where each patch is associated with a region of blendshape model 210. Each patch includes a set of blendweight values associated with the patch, where the blendweight values define a per-patch linear combination of the neutral facial depictions included in facial database 200.

In operation 406, blendshape engine 122 iteratively optimizes the blendweight values associated with each patch included in blendshape model 210 via blendweight optimizer 260. Blendshape engine 122 optimizes the blendweight values based on one or more samples of a target character and one or more energy function values. As discussed above in the description of FIG. 2, blendweight optimizer 260 minimizes one or more of a fitting energy value, regularization energy value, or overlap energy value. Blendshape engine 122 may optimize the blendweight values associated with the multiple patches for a predetermined number of iterations or until one or more of the energy function values is below a predetermined threshold. Blendshape engine 122 also iteratively optimizes, via blendshape optimizer 250, vertex positions associated with one or more vertexes included in blendshape model 210 based on one or more expressive depictions of the target character included in character samples 220.

In operation 408, blendshape engine 122 generates output facial rig 270. Output facial rig 270 includes an adjustable model representing the target character, where the adjustable model includes multiple vertices and multiple meshes defined by the multiple vertices.

In operation 410, blendshape engine 122 generates one or more expression deltas based on a generic prior model. Each expression delta of the one or more expression deltas represents differences in vertex positions between a neutral facial depiction of the generic prior model and an expressive depiction of the generic prior model, such as a depiction where the generic prior model includes a smiling or frowning expression.

In operation 412, blendshape engine 122 generates one or more expressive depictions of the target character based on output facial rig 270 and the one or more expression deltas. Each expression delta, when applied to output facial rig 270, generates a depiction of the target character exhibiting the expression associated with the expression delta, e.g., smiling or frowning.

FIG. 5 is a flow diagram of method steps for performing identity-based facial rig generation based on neutral and expressive depictions, according to some embodiments. Although the method steps are described in conjunction with the systems of FIGS. 1 and 2, persons skilled in the art will understand that any system configured to perform the method steps in any order falls within the scope of the present disclosure.

As shown, in operation 502 of method 500, blendshape engine 122 retrieves one or more neutral facial depictions and one or more expressive facial depictions included in facial database 200. Each of the one or more neutral facial depictions and the one or more expressive facial depictions is associated with one of one or more different identities included in facial database 200.

In operation 504, blendshape engine 122 generates blendshape model 210, where blendshape model 210 includes a multi-linear identity model. Blendshape model 210 includes one or more vertices, one or more meshes defined by the vertices, and one or more patches, where each patch is associated with a region of blendshape model 210. Each patch includes a set of blendweight values associated with the patch, where the blendweight values define a per-patch multi linear combination of the neutral facial depictions and expressive facial depictions included in facial database 200. Each of the blendweight values encodes an identity included in facial database 200 along one tensor dimension, and an expressive depiction included in facial database 200 and associated with the identity along a second, orthogonal tensor dimension.

In operation 506, blendshape engine 122 iteratively optimizes the blendweight values associated with each patch included in blendshape model 210 via blendweight optimizer 260. Blendshape engine 122 optimizes the blendweight values based on one or more samples of a target character and one or more energy function values. As discussed above in the description of FIG. 2, blendweight optimizer 260 minimizes one or more of a fitting energy value, regularization energy value, or overlap energy value. Blendshape engine 122 may optimize the blendweight values associated with the multiple patches for a predetermined number of iterations or until one or more of the energy function values is below a predetermined threshold.

In operation 508, blendshape engine 122 generates output facial rig 270. Output facial rig 270 includes an adjustable model representing the target character, where the adjustable model includes multiple vertices and multiple meshes defined by the multiple vertices.

In operation 510, blendshape engine 122 generates one or more expression deltas based on a generic prior model. Each expression delta of the one or more expression deltas represents differences in vertex positions between a neutral facial depiction included in facial database 200 and associated with an identity and an expressive depiction included in facial database 200 and associated with the identity, such as an expressive depiction that includes a smiling or frowning expression.

In operation 512, blendshape engine 122 generates one or more expressive depictions of the target character based on output facial rig 270 and the one or more expression deltas. Each expression delta, when applied to output facial rig 270, generates a depiction of the target character exhibiting the expression associated with the expression delta, e.g., smiling or frowning.

In sum, the disclosed techniques perform facial rig generation to create an adaptable blendshape model of a target character's head and/or face. In various embodiments, the facial rig generation may include creating an initial generic blendshape model based on a facial database that includes both neutral and expressive facial depictions of multiple different identities. The disclosed techniques optimize the generic blendshape model to represent the target character based on one or more user-supplied expressive facial depictions of the target character. Both the blendshape model and the facial depictions included in the facial database include vertices and meshes defined by the vertices. Further, both the blendshape model and the facial depictions include multiple patches, where each patch is associated with a region of the facial depiction or the blendshape model.

In operation, a blendshape engine generates an initial generic blendshape model including multiple vertices and multiple triangular meshes defined by the vertices. The blendshape engine also generates a user-defined patch layout where each of multiple patches is associated with a region of the generic blendshape model.

The blendshape engine optimizes the generic blendshape model to represent a target character, based on one or more expressive sample facial depictions of the target character and a facial database containing both neutral and expressive facial depictions associated with multiple identities that are different from the target character. The disclosed techniques optimize the blendshape model at a per-patch level, both by adjusting blendweights associated with each patch, and/or by modifying vertex positions to adjust the shape of each patch. The blendweights associated with each patch define a weighted combination of multiple corresponding patches included in the facial database.

In some embodiments, the blendshape engine leverages only the neutral facial depictions included in the facial database, where each neutral expression in the facial database is associated with a different identity. The blendshape engine generates a patch-based identity model based on a linear weighted combination of the neutral facial depictions. For each patch in the identity model, the blendshape engine calculates a set of patch identity weights associated with corresponding patches included in the neutral facial depiction in the facial database. The blendshape engine iteratively optimizes the patch identity weights included in the identity model based on one or more expressive sample facial depictions of the target character.

The blendshape engine may optimize vertex positions included in the identity model in addition to optimizing the patch identity weights as described above. For each expressive sample facial depiction of the target character, the blendshape engine iteratively adjusts one or more vertex positions included in the identity model to optimize the identity model's representation of the sample facial depiction. The blendshape engine stores the adjusted vertex positions for each sample facial depiction as vertex offset deltas in a canonical coordinate system. Based on the vertex offset deltas, the blendshape engine is operable to generate a blendshape model for a target character whose facial structure differs significantly from the facial structures of the identities included in the facial database.

In some embodiments, the blendshape engine may leverage both the neutral and expressive facial depictions included in the facial database, rather than only the neutral facial depictions. In these embodiments, the blendshape engine includes a patch-based multi-linear model that encodes identities included in the facial database along one tensor dimension and expressions included in the facial database along a second, orthogonal tensor dimension. The blendshape engine optimizes patch identity weights for each patch associated with the identity model based on a weighted multi-linear combination of patches from both neutral and expressive depictions included in the facial database. For each expressive sample facial depiction of the target character, the blendshape engine generates a full set of expression deltas that, when applied to the identity model, generate the expressive sample facial depiction.

One technical advantage of the disclosed techniques relative to the prior art is that the disclosed techniques are operable to generate a facial rig for a particular animated character using only a limited number of depictions of the character. Various embodiments of the disclosed techniques may also be guided and constrained by actor depictions including studio images or in-the-wild images, rather than requiring 3D scans of an actor's face. Further, the disclosed techniques improve accuracy and realism in generated facial expressions via a patch-based optimization method, where the disclosed techniques process a facial representation as a collection of independent regions within the representation, rather than as a monolithic whole. These technical advantages provide one or more technological improvements over prior art approaches.

1. In some embodiments, a computer-implemented method for performing local facial rig generation comprises generating a blendshape model including a plurality of vertices, a plurality of meshes, and a plurality of patches, modifying one or more blendweight values associated with each of the plurality of patches based on a plurality of facial depictions included in a facial database and one or more sample depictions of a target character, generating an output facial rig model based on the blendshape model and the one or more modified blendweight values, and generating one or more expressive depictions of the target character based at least on the output facial rig.

2. The computer-implemented method of clause 1, wherein each facial depiction included in the facial database is associated with one of multiple identities.

3. The computer-implemented method of clauses 1 or 2, wherein the facial database includes a neutral facial expression associated with one of the multiple identities and one or more expressive facial expressions associated with the one of the multiple identities.

4. The computer-implemented method of any of clauses 1-3, wherein the one or more blendweight values associated with each of the plurality of patches define a weighted linear combination of corresponding patches associated with the plurality of facial depictions included in the facial database.

5. The computer-implemented method of any of clauses 1-4, further comprising modifying one or more vertex positions associated with the plurality of vertices included in the blendshape model.

6. The computer-implemented method of any of clauses 1-5, wherein each of the plurality of patches is associated with a region included in the blendshape model.

7. The computer-implemented method of any of clauses 1-6, wherein generating the one or more expressive depictions of the target character is further based on an expression delta.

8. The computer-implemented method of any of clauses 1-7, wherein the expression delta defines one or more vertex position differences associated with vertices included in a neutral depiction of a generic prior model and corresponding vertices included in an expressive depiction of the generic prior model.

9. The computer-implemented method of any of clauses 1-8, wherein modifying the one or more blendweight values is based on minimizing one or more energy value functions.

10. The computer-implemented method of any of clauses 1-9, wherein the one or more sample depictions of the target character do not include a neutral depiction of the target character.

11. In some embodiments, one or more non-transitory computer-readable media containing instructions that, when executed by one or more processors, cause the one or more processors to perform the steps of generating a blendshape model including a plurality of vertices, a plurality of meshes, and a plurality of patches, modifying one or more blendweight values associated with each of the plurality of patches based on a plurality of facial depictions included in a facial database and one or more sample depictions of a target character, generating an output facial rig model based on the blendshape model and the one or more modified blendweight values, and generating one or more expressive depictions of the target character based at least on the output facial rig.

12. The one or more non-transitory computer-readable media of clause 11, wherein each facial depiction included in the facial database is associated with one of multiple identities.

13. The one or more non-transitory computer-readable media of clauses 11 or 12, wherein the facial database includes a neutral facial expression associated with one of the multiple identities and one or more expressive facial expressions associated with the one of the multiple identities.

14. The one or more non-transitory computer-readable media of any of clauses 11-13, wherein the one or more blendweight values associated with each of the plurality of patches define a weighted linear combination of corresponding patches associated with the plurality of facial depictions included in the facial database.

15. The one or more non-transitory computer-readable media of any of clauses 11-14, wherein the instructions further cause the one or more processors to perform the step of modifying one or more vertex positions associated with the plurality of vertices included in the blendshape model.

16. The one or more non-transitory computer-readable media of any of clauses 11-15, wherein each of the plurality of patches is associated with a region included in the blendshape model.

17. The one or more non-transitory computer-readable media of any of clauses 11-16, wherein the step of generating the one or more expressive depictions of the target character is further based on an expression delta.

18. The one or more non-transitory computer-readable media of any of clauses 11-17, wherein the expression delta defines one or more vertex position differences associated with vertices included in a neutral depiction of a generic prior model and corresponding vertices included in an expressive depiction of the generic prior model.

19. In some embodiments, a system comprises one or more memories for storing instructions, and one or more processors for executing the instructions to generate a blendshape model including a plurality of vertices, a plurality of meshes, and a plurality of patches, modify one or more blendweight values associated with each of the plurality of patches based on a plurality of facial depictions included in a facial database and one or more sample depictions of a target character, generate an output facial rig model based on the blendshape model and the one or more modified blendweight values, and generate one or more expressive depictions of the target character based at least on the output facial rig.

20. The system of clause 19, wherein the one or more blendweight values associated with each of the plurality of patches define a weighted linear combination of corresponding patches associated with the plurality of facial depictions included in the facial database. Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing local facial rig generation, the method comprising:
generating a blendshape model including a plurality of vertices, a plurality of meshes, and a plurality of patches;
modifying one or more blendweight values associated with each of the plurality of patches based on a plurality of facial depictions included in a facial database and one or more sample depictions of a target character;
generating an output facial rig model based on the blendshape model and the one or more modified blendweight values; and
generating one or more expressive depictions of the target character based at least on the output facial rig.

2. The computer-implemented method of claim 1, wherein each facial depiction included in the facial database is associated with one of multiple identities.

3. The computer-implemented method of claim 2, wherein the facial database includes a neutral facial expression associated with one of the multiple identities and one or more expressive facial expressions associated with the one of the multiple identities.

4. The computer-implemented method of claim 1, wherein the one or more blendweight values associated with each of the plurality of patches define a weighted linear combination of corresponding patches associated with the plurality of facial depictions included in the facial database.

5. The computer-implemented method of claim 1, further comprising modifying one or more vertex positions associated with the plurality of vertices included in the blendshape model.

6. The computer-implemented method of claim 1, wherein each of the plurality of patches is associated with a region included in the blendshape model.

7. The computer-implemented method of claim 1, wherein generating the one or more expressive depictions of the target character is further based on an expression delta.

8. The computer-implemented method of claim 7, wherein the expression delta defines one or more vertex position differences associated with vertices included in a neutral depiction of a generic prior model and corresponding vertices included in an expressive depiction of the generic prior model.

9. The computer-implemented method of claim 1, wherein modifying the one or more blendweight values is based on minimizing one or more energy value functions.

10. The computer-implemented method of claim 1, wherein the one or more sample depictions of the target character do not include a neutral depiction of the target character.

11. One or more non-transitory computer-readable media containing instructions that, when executed by one or more processors, cause the one or more processors to perform the steps of:
generating a blendshape model including a plurality of vertices, a plurality of meshes, and a plurality of patches;
modifying one or more blendweight values associated with each of the plurality of patches based on a plurality of facial depictions included in a facial database and one or more sample depictions of a target character;
generating an output facial rig model based on the blendshape model and the one or more modified blendweight values; and
generating one or more expressive depictions of the target character based at least on the output facial rig.

12. The one or more non-transitory computer-readable media of claim 11, wherein each facial depiction included in the facial database is associated with one of multiple identities.

13. The one or more non-transitory computer-readable media of claim 12, wherein the facial database includes a neutral facial expression associated with one of the multiple identities and one or more expressive facial expressions associated with the one of the multiple identities.

14. The one or more non-transitory computer-readable media of claim 11, wherein the one or more blendweight values associated with each of the plurality of patches define a weighted linear combination of corresponding patches associated with the plurality of facial depictions included in the facial database.

15. The one or more non-transitory computer-readable media of claim 11, wherein the instructions further cause the one or more processors to perform the step of modifying one or more vertex positions associated with the plurality of vertices included in the blendshape model.

16. The one or more non-transitory computer-readable media of claim 11, wherein each of the plurality of patches is associated with a region included in the blendshape model.

17. The one or more non-transitory computer-readable media of claim 11, wherein the step of generating the one or more expressive depictions of the target character is further based on an expression delta.

18. The one or more non-transitory computer-readable media of claim 17, wherein the expression delta defines one or more vertex position differences associated with vertices included in a neutral depiction of a generic prior model and corresponding vertices included in an expressive depiction of the generic prior model.

19. A system comprising:
one or more memories for storing instructions; and
one or more processors for executing the instructions to:
generate a blendshape model including a plurality of vertices, a plurality of meshes, and a plurality of patches;
modify one or more blendweight values associated with each of the plurality of patches based on a plurality of facial depictions included in a facial database and one or more sample depictions of a target character;
generate an output facial rig model based on the blendshape model and the one or more modified blendweight values; and
generate one or more expressive depictions of the target character based at least on the output facial rig.

20. The system of claim 19, wherein the one or more blendweight values associated with each of the plurality of patches define a weighted linear combination of corresponding patches associated with the plurality of facial depictions included in the facial database.
